(19) United States
(12) Patent Application Publication
(10) Pub. No.: US 2007/0088720 A1
(43) Pub. Date: Apr. 19, 2007

(54) Method for detecting discrepancies between a user's perception of web sites and an author's intention of these web sites

(75) Inventors: Ralph Neuneier, Munich (DE); Michal Skubacz, Groebenzell (DE); Carsten Dirk Stolz, Munich (DE); Maximilian Vermetz, Munich (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munich (DE)

(21) Appl. No.: 11/250,573

(22) Filed: Oct. 17, 2005

(51) Int. Cl. G06F 7/00

(52) U.S. Cl. 707/100

(57) ABSTRACT

Method of computer-based detection of discrepancy between a user's perception of web sites and an author's intention of these web sites, wherein user interactions are gathered and combined with the content of individual web pages, the combination thereof is clustered topically, and a respective topical distance of the web pages is compared to a structural distance of the web pages, which results from the author's elected arrangement of the web pages to each other, whereby the difference in both distances gives the discrepancy in the user's perception and the author's intention of the web pages, characterized in that at least parts of the text are extracted from the web pages for building keywords, which represent the contents of such web pages.

### BACKGROUND OF THE INVENTION

Web Mining provides many approaches to analyze usage, user navigation behavior, as well as content and structure of web sites. They are used for a variety of purposes ranging from reporting to personalization and marketing intelligence. In most cases the results obtained, such as user groups or click streams are difficult to interpret. Moreover practical application of them is even more difficult.

There has not yet been found a way to analyze web data giving clear recommendations for web site authors on how to improve the web site by adapting to users' interests. For this purpose, such interest has to be first identified and evaluated. However, since corporate web sites are analyzed that mainly provide information, but no e-commerce, there is no transactional data available. Transactions usually provide insight into the user's interest: what the user is buying, that is what he or she is interested in. But facing purely information driven web sites, other approaches must be developed in order to reveal user interest.

Zhu et al analyze user behavior in order to improve web site navigation, by analyzing user paths to find semantic relations between web pages (Zhu, J.; Hong, J.; Hughes, J. G., Page Cluster: Mining Conceptual Link Hierarchies from Web Log Files for Adaptive Web Site Navigation, ACM Journal Transaction on Internet Technology, 2004, Vol.4, Nr.2, p. 185-208). They propose a way to construct a conceptual link hierarchy.

However, this approach does not incorporate the content of web pages and thus does not identify content-based similarities.

Sun et al. classify web pages, especially by evaluating sub graphs instead of single pages (A. Sun and E. P. Lim. Web Unit Mining: Finding and Classifying Sub Graphs of Web Pages. In Proceedings 12th Int. Conf. on Information and Knowledge Management, p. 108-115, ACM Press, 2003). Their work is based on URLs and thus not generic. Since they are also interested in improving their classification algorithm, they have concentrated on applying the gained knowledge in improving the usability of a web site.

User interest is also the focus of Oberle et al. (D. Oberle; B. Berendt; A. Hotho; J. Gonzalez; Conceptual User Tracking, Proceedings of the Atlantic Web Intelligence Conference, 2002, p. 155 -164). They enhance web usage data with formal semantics from existing ontologies. The main goal of this work is to resolve cryptic URLs by semantic information provided by a Semantic Web. They do not use explicit semantic information, which excludes analysis of web pages where semantic web extensions are not available.

The comparison of perceived users' interests and author's intentions manifested in the web site content and structure can be applied as a web metric. A systematic survey of web related metrics can be found at Dhyani et al. (Dhyani, D.; Keong N G, W.; Bhowmick, S. S.; A Survey of Web Metrics, ACM Computing Surveys, 2002, vol. 34, nr. 4, p. 469-503).

### SUMMARY OF THE INVENTION

It is one possible object of present invention to automatically generate recommendations for information driven web sites enabling authors to incorporate users' perceptions of the site in the process of optimizing it.

Such object is solved by the aforementioned method, wherein at least parts of the text are extracted from the web pages for building keywords, which represent the contents of such web pages.

The design and organization of a website reflects the author's intent. Since user perception and understanding of websites may differ from the authors, we propose a way to identify and quantify this difference in perception. In our approach we extract perceived semantic focus by analyzing user behavior in conjunction with keyword similarity. By combining usage and content data we identify user groups with regard to the subject of the pages they visited. Our real world data shows that these user groups are nicely distinguishable by their content focus. By introducing a distance measure of keyword coincidence between web pages and user groups, we can identify pages of similar perceived interest. A discrepancy between perceived distance and link distance in the web graph indicates an inconsistency in the web sites design. Determining usage similarity allows the website author to optimize the content to the users' needs.

According to the method, a web site's structure, content as well as usage data are combined and analyzed. For this purpose we collect the content and structure data using an automatic crawler. The usage data we gather with the help of a web tracking system integrated into a large corporate web site system.

A tracking mechanism on the analyzed web sites collects each click, session information as well as additional user details. In an ETL (Extraction-Transform-Load) process user sessions are created. The problem of session identification occurring with log files is overcome by the tracking mechanism, which allows easy construction of sessions.

Combining usage and content data and applying clustering techniques, we create user interest vectors. We analyze the relationships between web pages based on the common user interest, defined by the previously created user interest vectors. Finally we compare the structure of the web site with the user perceived semantic structure. The comparison of both structure analyses helps us to generate recommendations for web site enhancements.

We describe a generic approach for all kinds of web sites and applications (e-commerce, non-e-commerce, collaboration, with/without transaction) and their usage patterns. By this, web site/application owners may create better structured web sites through an improved matching of usage and intention. An operational advantage is the design of one concluding indicator, which identifies problems of a web site directly based on an analysis of the whole web site.

In one aspect of present invention the extracted keywords are cleaned from single occurring words, stop words and stems. From the web page text we can extract key words. In order to increase effectivity, one usually only considers the most common occurring key words. In general the resulting key word vector for each web page is proportional to text length. In our experiments we decided to use all words of a web page since by limiting their number one loses infrequent but important words. Keywords that occur only on one web page cannot contribute to web page similarity and can therefore be excluded. This helps to reduce dimensionality. To further reduce noise in the data set additional processing is necessary, in particular applying a stop word list, which removes given names, months, fill words and other non-essential text elements. Afterwards we reduce words to their stems with Porters stemming method.

In order to have compatible data sets, navigational pages and crawlers are excluded from gathering the user's interactions and the contents of web pages. We identify foreign potential crawler activity thus ignoring bots and crawlers searching the website since we are solely interested in user interaction. Furthermore we identify special navigation and support pages, which do not contribute to the semantics of a user session. Home, Sitemap, Search are unique pages occurring often in a click stream, giving hints about navigational behavior but providing no information about the content focus of a user session. Due to the fact that the web pages are supplied by a special content management system (CMS), the crawler can send a modified request to the CMS to deliver the web page without navigation. This allows us to concentrate on the content of a web page and not on the structural and navigational elements. From these distilled pages we collect textual information, HTML mark-up and Meta information. We have evaluated meta-information and found it is not consistently maintained throughout websites. Also, HTML mark-up cannot be relied upon to reflect the semantic structure of web pages. In general HTML tends to carry design information, but does not emphasize importance of information within a page.

For building a basis suitable for further processing of collected data, the user's data is stored in a user-(session)-matrix and the content data of the web pages is stored in a web-page-keyword-matrix. Using i sessions and j web pages (identified by content IDs) we can now create the user-session-matrix U_{i,j}. From the cleaned database with j web pages and k unique keywords we create the web-page-keyword-matrix C_{j,k}.

One object of this approach is to identify what users are interested in. In order to achieve this, it is not sufficient to know which pages a user has visited, but the content of all pages of a user session. Therefore we combine user data U_{i,j} with content data C_{i,k,} by multiplying both matrices obtaining a user-keyword-matrix CF_{i,k}=U_{i,j}×C_{j,k}. This matrix shows the content of a user session, represented by keywords.

In order to find user session groups with similar interest, we cluster sessions by keywords. We have chosen to use standard multivariate analysis for identification of user and content cluster. Related techniques are known for smoothing the keyword space in order to reduce dimensionality and improve clustering results (Stolz,C.; Gedov,V.; Yu,K.; Neuneier,R.; Skubacz,M.; Measuring Semantic Relations of Web Sites by Clustering of Local Context, ICWE2004, Munich(2004), In Proc. International Conference on Web Engineering 2004, Springer, p. 182-186). For estimating the n number of groups, we perform a principal component analysis on the scaled matrix CF_{i,j} and inspect the data. In order to create reliable cluster partitions, we have to define an initial partitioning of the data. We do so by clustering CF_{i,k} hierarchically. We have evaluated the results of hierarchical clustering using Single-, Complete- and Average-Linkage methods.

For all data sets the Complete-Linkage method has shown the best experimental results. It is therefore preferred to use this method for initial clustering. We extract n groups defined by the hierarchical clustering and calculate the within group distance dist(partition). The data point with the minimum distance within a partition is chosen as one of n starting points of the initial partitioning for the assignment algorithm.

The previously determined partitioning initializes a standard k-Means clustering assigning the individual user-sessions to the clusters of similar interest. We identify user groups with regard to the subject of the pages they visited, clustering users with the same interest. To find out in which topics the users in each group are interested in, we regard the keywords in each cluster. Generally, also other cluster algorithms may be used, including ‘Probabilistic Latent Semantic Indexing by Expectation Maximization’ or ‘Gaussian Mixture Models’.

We create an interest vector for each user group by summing up the keyword vectors of all user sessions within one cluster. The result is a user interest matrix Ul_{k,n} for all n clusters. Afterwards we subtract the mean value over all clusters of each keyword from the keyword value in each cluster.

Having the keyword based topic vectors for each user group available in Ul_{k,n}, we combine them with the content matrix C_{j,k}×x Ul_{k,n}. The resulting matrix Cl_{j,n} explains how strong each content ID (web page) is related to each User Interest Group Ul_{k,n}. The degree of similarity between content perceived by the user can now be seen as the distances between content IDs based on the Cl_{j,n} matrix. The shorter the distance, the greater the similarity of content IDs in the eyes of the users.

We now compare the above-calculated distance matrix Cl_{dist} with the distances in an adjacency matrix of the web site graph of the regarded web site. Comparing both distance matrices, discrepancy between perceived distance and eg link distance in the web graph indicates an inconsistency in the web sites design. If two pages have the similar distance regarding user perception as well as link distance, then users and web authors have the same understanding of the content of the two pages and their relation to each other. If the distances are different, then either users do not use the pages in the same context or they need more clicks than their content focus would permit. In the eyes of the user, the two pages belong together but are not linked, or the other way around. For better comparison of the web pages the distance matrix and the adjacency matrix are scaled.

The adjacency matrix is preferably given by the navigational distance of the web pages, using the shortest click distance there between, ie shortest distance in the web site graph. A suitable method is represented by the Dijkstra Algorithm, which calculates such shortest path. However, also other methods may be used, including Kruskal, geodesic distances etc, which are generally methods and heuristics for determining shortest path in graphs.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a flow chart with the main steps of one embodiment of the inventive method; and

FIG. 2 shows a sample consistency check.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

We applied the above presented approach to two corporate web sites. Each deals with different topics and is different concerning size, subject and user accesses. With this case study we evaluate our approach employing it on both web sites. We begin with the data preparation of content and usage data and the reduction of dimensionality during this process.

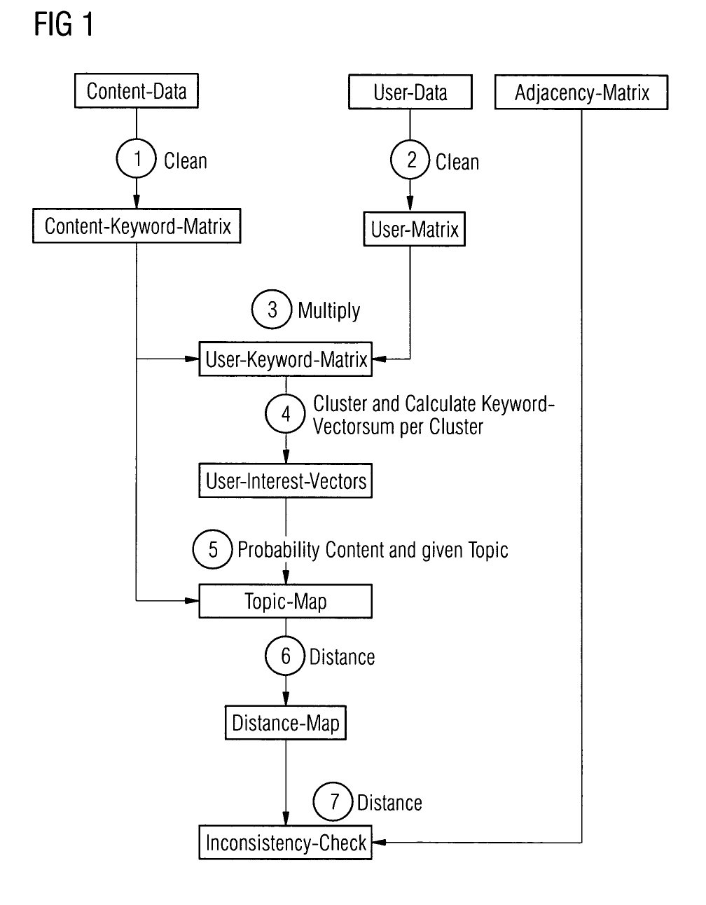

FIG. 1 shows a flow chart with the main steps of one embodiment of the inventive method. For our approach we analyze usage as well as content data. We consider usage data to be user actions on a web site, which are collected by a tracking mechanism. We extract content data from web pages with the help of a crawler. FIG. 1 depicts the major steps of our algorithm. Data preparation steps are marked with 1 (Content-Data) and 2 (User-Data). In step 3 usage and content data are combined.

Further the combined data is used for the identification of the user interest groups. To identify topics we calculate the key word vector sums of each cluster in step 4. Probabilities of a web page belonging to one topic are calculated in step 5. Afterwards in step 6 the distances between the web pages are calculated, in order to compare them in the last step 7 with the distances in the link graph. As a result we can identify inconsistencies between web pages organized by the web designer and web pages grouped by users with the same interest. That is, the steps in FIG. 1 are as follows:
1 Clean Content-Data to form a Content-Keyword-Matrix C_{j,k}
2 Clean User-Data to form a User-Matrix U_{i,j}
3 Multiply U_{i,j} with Cj,kto form a User-Keyword-Matrix CF_{i,k}
4 Cluster CF_{i,k} to form a User-Group-Interest-Matrix Ul_{k,l}
5 Multiply Ul_{k,}n with C_{j,k} to form a Content Matrix Cl_{j,n}
6 Subtract Cl_{j,n} from Ul_{k,n} to form a Distance Matrix Cl_{dist}
7 Subtract Distᵤₛₑᵢₙₜₑᵣₑₛₜ from Adjacency Matrix Dist_{Link}

In all projects dealing with real world data the inspection and preparation of data is essential for reasonable results. Raw usage data includes 13302 user accesses in 5439 sessions in this case study.

TABLE 1
Data Cleaning Steps for User-Data

| Cleaning | Data | Dimensions |
|---|---|---|
| Step | Sets | (Session-ID × Keyword) |
| Raw Data | 13398 | 5349 × 283 |
| Exclude Crawler | 13228 | 5343 × 280 |
| Adapt to Content Data | 13012 | 5292 × 267 |

As to the content data 278 web pages are crawled first. Table 2 explains the cleaning steps and the dimensionality reductions resulting there from. We have evaluated the possibility to reduce the keyword vector space even more by excluding keywords occurring only on two or three pages.

TABLE 2
Data Cleaning Steps for Content Data

| Cleaning | Data | Dimensions |
|---|---|---|
| Step | Sets | (Session-ID × Keyword) |
| Raw Data | 2001 | 278 × 501 |
| Content IDs wrong language | 1940 | 270 × 471 |
| Exclude Home, Sitemap, Search | 1904 | 264 × 468 |
| Exclude Crawler | 1879 | 261 × 466 |
| Delete Single Keywords | 1650 | 261 × 237 |
| Delete Company Name | 1435 | 261 × 236 |

We combine user and content data by multiplying both matrices obtaining a User-Keyword-Matrix CF_{i,k}=C_{j,k} with i=4568 user sessions, j=247 content IDs and k=1258 keywords. We perform a principal component analysis on the matrix CF_{i,k} to determine the n number of clusters. This number varies from 9 to 30 clusters depending on the size of the matrix and the subjects the web site is dealing with. The Kaiser criteria can help to determine the number of principal components necessary to explain half of the total sample variance.

We perform a principal component analysis along with a hierarchical clustering. We chose different number of clusters varying around this criteria and could not see major changes in the resulting cluster numbers. Standard k-Means clustering provided the grouping of CF_{i,k} into n cluster. We calculate the keyword vector sums per each cluster, building the total keyword vector for each cluster. The result is a User-Group-Interest-Matrix Ul_{k,n}. vector (6) is (7) given (8) here (9): treasur Part (1) of (2) an (3) user (4) interest (5)—solu—finan—servi—detai. We now want to provide a deeper insight into the application of the results. We have calculated a Distance Matrix dist(Cl_{j,n}) as described above.

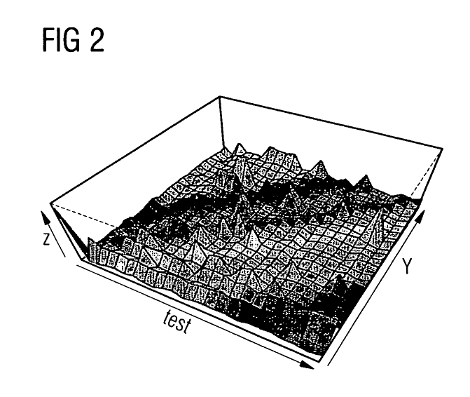

We scale both distance matrices, the user dist(Cl_{j,n}) and Adjacency-Matrix Dist_{Link} to variance 1 and mean 0 in order to make them comparable. Then we calculate their difference Didtᵤₛₑᵣᵢₙₜₑᵣₑₛₜ−Dist_{Link}. We get a matrix with as many columns and rows as there are web pages, comparing every web page (content IDs) with each other. We are interested in the differences between user perception and author intention, which are identifiable as peak values when subtracting the User-Matrix from the Adjacency-Matrix as shown in FIG. 2.

FIG. 2 shows a sample consistency check, wherein the set of peaks, each of which identifies pairs of web pages, now forms the candidates put forward for manual scrutiny by the web site author, who can update the web site structure if he or she deems it necessary.

We have presented a way to show weaknesses in the current structure of a web site in terms of how users perceive the content of that site. We have evaluated our approach on two different web sites, different in subject, size and organization. The recommendation provided by this approach has still to be evaluated manually, but since we face huge web sites, it helps to focus on problems the users have. Solving them promises a positive effect on web site acceptance. The ultimate goal will be measurable by a continued positive response over time.

This work is part of the idea to make it possible to evaluate information driven web pages. Our current research will extend this approach with the goal to create metrics, that should give clues about the degree of success of a user session. A metric of this kind would make the success of the whole web site more tangible. For evaluation of a successful user session we will use the referrer information of users coming from search engines. The referrer provides us with these search strings. Compared with the user interest vector a session can be made more easily evaluated.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

What is claimed is:

1. A method to detect a discrepancy between a user's perception of web sites having web pages and an author's intention for these web sites, comprising:
gathering user interaction information regarding how a user navigates between web pages;
building keywords based on text extracted from the web pages;
using the keywords to represent contents of the web pages;
topically combining the user interaction information with the contents of the web pages;
for each web page, determining a structural distance of the web page to other web pages based on how an author of the web page has arranged the web page with respect to other web pages; and
for each web page, comparing a topical distance of the web page to the structural distance of the web page, whereby a difference in the distances gauges the discrepancy between the user's perception of and the author's intention for the web page.

2. A method according to claim 1, wherein single occurring words, stop words and stems are filtered from the extracted text before the keywords are used to represent contents of the web pages.

3. A method according to claim 1, wherein navigational pages and crawlers are excluded when gathering user interaction information and representing contents of web pages.

4. A method according to claim 1, wherein the interaction information is stored in a user-session-matrix and the contents of the web pages is stored in a web-page keyword-matrix.

5. A method according to claim 4, wherein the user-session matrix and the web-page-keyword-matrix are multiplied for establishing a user-keyword-matrix.

6. A method according to claim 5, wherein user-sessions of the user-session-matrix are clustered by similar interests.

7. A method according to claim 6, wherein an initial clustering is made using a complete-linkage-method.

8. A method according to claim 2, wherein navigational pages and crawlers are excluded when gathering user interaction information and representing contents of web pages.

9. A method according to claim 8, wherein the interaction information is stored in a user-session-matrix and the contents of the web pages is stored in a web-page keyword-matrix.

10. A method according to claim 9, wherein the user-session matrix and the web-page-keyword-matrix are multiplied for establishing a user-keyword-matrix.

11. A method according to claim 10, wherein user-sessions of the user-session-matrix are clustered by similar interests.

12. A method according to claim 12, wherein an initial clustering is made using a complete-linkage-method.

13. A computer readable medium storing a program to control a computer to perform a method to detect a discrepancy between a user's perception of web sites having web pages and an author's intention for these web sites, the method comprising:
gathering user interaction information regarding how a user navigates between web pages;
building keywords based on text extracted from the web pages;
using the keywords to represent contents of the web pages;
topically combining the user interaction information with the contents of the web pages;
for each web page, determining a structural distance of the web page to other web pages based on how an author of the web page has arranged the web page with respect to other web pages; and
for each web page, comparing a topical distance of the web page to the structural distance of the web page, whereby a difference in the distances gauges the discrepancy between the user's perception of and the author's intention for the web page.
